(19) United States
(12) Patent Application Publication
(10) Pub. No.: US 2009/0051196 A1
(43) Pub. Date: Feb. 26, 2009

(54) SHEET HEATING ELEMENT AND SEAT MAKING USE OF THE SAME

(75) Inventors: Takahito Ishii, Kyoto (JP); Seishi Terakado, Nara (JP); Katsuhiko Uno, Nara (JP); Hirosi Fukuda, Nara (JP); Hiroyuki Ogino, Nara (JP); Keizo Nakajima, Osaka (JP)

Correspondence Address: RATNERPRESTIA, P.O. BOX 980, VALLEY FORGE, PA, 19482, US

(73) Assignee: MATSUSHITA ELECTRIC INDUSTRIAL., LTD., Osaka (JP)

(21) Appl. No.: 12/278,624

(22) PCT Filed: Jul. 13, 2006
(86) PCT No.: PCT/JP2006/313938

§ 371 Date: Aug. 7, 2008

(30) Foreign Application Priority Data
Mar. 29, 2006 (JP) 2006-091176
Mar. 29, 2006 (JP) 2006-091177
Mar. 29, 2006 (JP) 2006-091178

(51) Int. Cl. A47C 7/72; H05B 3/34

(52) U.S. Cl. 297/180.12; 219/549

(57) ABSTRACT

The seating element has an electrically insulative substrate, a pair of electrodes disposed on the substrate, and a polymer resistor electrically connected to the electrodes. The polymer resistor includes resin composition cross-linked via one of oxygen atom and nitrogen atom, and at least one of fibrous conductor and flake-like conductor mixed in the resin composition.

This application is a U.S. National Phase Application of PCT International Application PCT/JP2006/313938.

### TECHNICAL FIELD

The present invention relates to a thin sheet heating element which is flexible enough to be mounted in a sheet-form apparatus, having excellent reliability and PTC characteristics. Also, the present invention relates to a seat using the sheet heating element.

### BACKGROUND ART

Conventional sheet heating elements are disclosed in Unexamined Japanese Patent Publication S56-13689, Unexamined Japanese Patent Publication H8-120182, and U.S. Pat. No. 7,049,559. For the heater section of a sheet heating element of this kind, a resistor made by printing and drying resistor ink, with base polymer and conductive material dispersed in a solvent, on a substrate is used. The resistor generates heat with power supplied. Generally, for a resistor of this kind, carbon black, metal powder or graphite is used as the conductive material, while crystalline resin is used as the base polymer. Due to such materials, the heater section displays PTC characteristics.

FIG. 21 is a perspective plan view of a conventional sheet heating element. FIG. 22 is a sectional view across the line 22-22 of FIG. 21. As shown in FIG. 21 and FIG. 22, sheet heating element 60 includes substrate 50, a pair of comb-like electrodes 51, 52, polymer resistor 53, and coating member 54. Electrically insulative substrate 50 is made of resin such as polyester film. Comb-like electrodes 51, 52 are formed by printing and drying conductive paste such as silver paste on substrate 50. Polymer resistor 53 is formed by printing and drying polymer resistor ink in a position where power is supplied via comb-like electrodes 51, 52. Coating member 54 being same in material as substrate 50 covers and protects comb-like electrodes 51, 52 and polymer resistor 53.

In a case that polyester film is used as substrate 50 and coating member 54, fusion-bonding resin 55 such as modified polyethylene, for example, is previously applied onto coating member 54. And it is heated under pressure. In this way, substrate 50 and coating member 54 are bonded to each other via fusion-bonding resin 55. Coating member 54 and fusion-bonding resin 55 serve to isolate comb-like electrodes 51, 52, and polymer resistor 53 from outside. Consequently, sheet heating element 60 has long-lasting reliability.

FIG. 23 shows a schematic sectional view of an apparatus for affixing coating member 54. As a method of heating under pressure, laminator 58 formed of two heating rolls 56, 57 is generally employed. That is, substrate 50 previously formed with comb-like electrodes 51, 52 and polymer resistor 53, and coating member 54 previously covered with fusion-bonding resin 55 are supplied, and these are heated under pressure by means of heating rolls 56, 57. Sheet heating element 60 is manufactured in this way.

PTC characteristics are resistance temperature characteristics such that a resistance value increases due to temperature rise and the resistance value abruptly increases when the temperature reaches a certain level. Polymer resistor 53 having PTC characteristics is able to give a self-temperature adjusting function to sheet heating element 60.

As described above, a rigid material such as polyester film is used as substrate 50 in conventional sheet hating element 60. Also, it has a five-layer structure including substrate 50, comb-like electrodes 51, 52 and polymer resistor 53 printed thereon, and coating member 54 further disposed thereon. As a result, it is lack of flexibility, depending upon the material and thickness of substrate 50 and coating member 54. That is, when sheet heating element 60 is used for a car seat heater (heater for heating the seat of a vehicle), it affects the feel of the seat adversely, and when used for a steering wheel heater, it affects the touch adversely.

In addition, because it is sheet-formed, when a load is applied to a part of the surface due to seating for example, the force is applied to the entire surface causing sheet heating element 60 to be deformed. Depending on the deformed shape, the closer to the end of sheet heating element 60, the amount of deformation is greater, and then, creases are generated on a part of the surface. There is a possibility that cracks are generated in comb-like electrodes 51, 52 or polymer resistor 53 at the creased portions. As a result, it gives rise to a possibility of lowering in durability.

Furthermore, since substrate 50 and coating member 54 such as polyester sheets having no permeability are employed, it is liable to get moist when used for a car sheet heater or a steering wheel heater. Accordingly, it affects the feel of the seat or the touch adversely when used for a long period of time.

### DISCLOSURE OF THE INVENTION

The present invention is a sheet heating element improved in touching feel and endurance reliability when mounted in an apparatus, which is given flexibility for absorbing deformation generated due to external forces. The sheet heating element of the present invention has an electrically insulative substrate, a pair of electrodes disposed on the substrate, and polymer resistor electrically connected to the electrodes. The polymer resistor includes resin composition cross-linked via one of oxygen atom and nitrogen atom, and at least one of fiber conductor and flake conductor which is mixed in the resin composition. Unlike the conventional five-layer sheet heating element, the sheet heating element is formed of three layers of substrate, electrode and polymer resistor in this configuration. Accordingly, it is possible to display flexibility and to reduce the cost.

### BRIEF DESCRIPTION OF THE DRAWINGS

FIG. 1A is a plan view showing a sheet heating element in accordance with a first exemplary embodiment of the present invention.

FIG. 1B is a sectional view of the sheet heating element shown in FIG. 1A.

FIG. 2 is a perspective side view showing a vehicle seat mounted with the sheet heating element in the exemplary embodiment of the present invention.

FIG. 3 is a perspective front view of the seat shown in FIG. 2.

FIG. 4A is a diagram for describing the PTC generating mechanism in a conventional configuration.

FIG. 4B is a diagram showing a state of temperature risen from the state shown in FIG. 4A.

FIG. 4C is a diagram for describing the PTC generating mechanism in the sheet heating element of the exemplary embodiments of the present invention.

FIG. 4D is a diagram showing a state of temperature risen from the state shown in FIG. 4C.

FIG. 5A is a plan view showing another sheet heating element in accordance with the first exemplary embodiment of the present invention.

FIG. 5B is a sectional view of the sheet heating element shown in FIG. 5A.

FIG. 6A is a plan view of further another sheet heating element in the first exemplary embodiment of the present invention.

FIG. 6B is a sectional view of the sheet heating element shown in FIG. 6A.

FIG. 7A is a plan view showing another sheet heating element in accordance with the first exemplary embodiment of the present invention.

FIG. 7B is a sectional view of the sheet heating element shown in FIG. 7A.

FIG. 8A is a plan view showing further another sheet heating element in accordance with the first exemplary embodiment of the present invention.

FIG. 8B is a sectional view of the sheet heating element shown in FIG. 8A.

FIG. 9A is a plan view of a sheet heating element in accordance with a second exemplary embodiment of the present invention.

FIG. 9B is a sectional view of the sheet heating element shown in FIG. 9A.

FIG. 10A is a plan view showing another sheet heating element in accordance with the second exemplary embodiment of the present invention.

FIG. 10B is a sectional view of the sheet heating element shown in FIG. 10A.

FIG. 11A is a plan view showing further another sheet heating element in accordance with the second exemplary embodiment of the present invention.

FIG. 11B is a sectional view of the sheet heating element shown in FIG. 11A.

FIG. 12A is a plan view showing still another sheet heating element in the second exemplary embodiment of the present invention.

FIG. 12B is a sectional view of the sheet heating element shown in FIG. 12A.

FIG. 13A is a plan view showing further another sheet heating element in accordance with the second exemplary embodiment of the present invention.

FIG. 13B is a sectional view of the sheet heating element shown in FIG. 13A.

FIG. 14A is a plan view showing a sheet heating element in accordance with a third exemplary embodiment of the present invention.

FIG. 14B is a sectional view of the sheet heating element shown in FIG. 14A.

FIG. 15A is a plan view showing another sheet heating element in accordance with the third exemplary embodiment of the present invention.

FIG. 15B is a sectional view of the sheet heating element shown in FIG. 15A.

FIG. 16A is a plan view showing further another sheet heating element in accordance with the third exemplary embodiment of the present invention.

FIG. 16B is a sectional view of the sheet heating element shown in FIG. 16A.

FIG. 17A is a plan view showing still another sheet heating element in accordance with the third exemplary embodiment of the present invention.

FIG. 17B is a sectional view of the sheet heating element shown in FIG. 17A.

FIG. 18A is a plan view showing further another sheet heating element in accordance with the third exemplary embodiment of the present invention.

FIG. 18B is a sectional view of the sheet heating element shown in FIG. 18A.

FIG. 19A is a plan view showing further another sheet heating element in accordance with the third exemplary embodiment of the present invention.

FIG. 19B is a sectional view of the sheet heating element shown in FIG. 19A.

FIG. 20A is a plan view showing further another sheet heating element in accordance with the third exemplary embodiment of the present invention.

FIG. 20B is a sectional view of the sheet heating element shown in FIG. 20A.

FIG. 21 is a perspective plan view of a conventional sheet heating element.

FIG. 22 is a sectional view of the sheet heating element shown in FIG. 21.

FIG. 23 is a sectional view showing the outline configuration of an example of a device for making a conventional sheet heating element.

### DETAILED DESCRIPTION OF THE PREFERRED EMBODIMENTS

The exemplary embodiments of the present invention will be described in the following with reference to the drawings. The present invention is not limited to the exemplary embodiments. Also, it is possible to properly combine the configurations peculiar to each exemplary embodiment.

### First Exemplary Embodiment

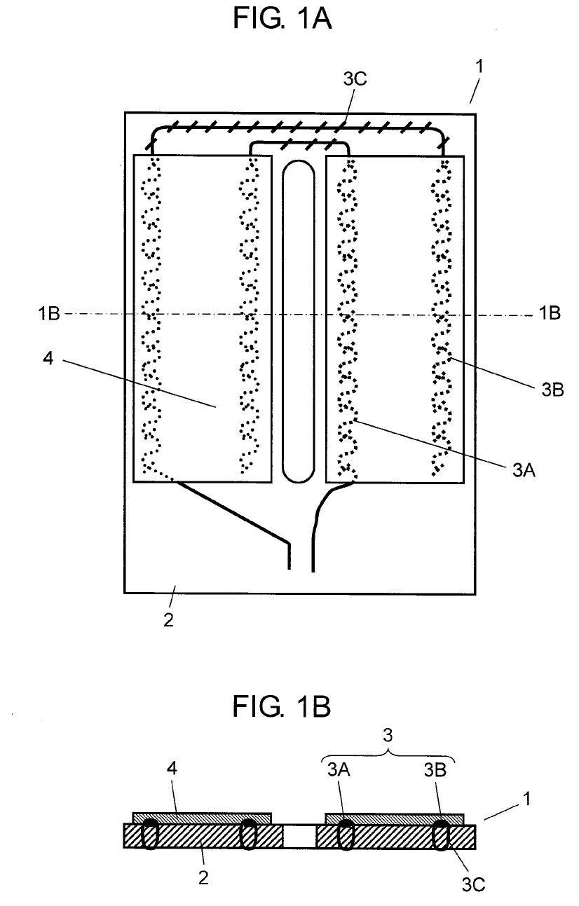

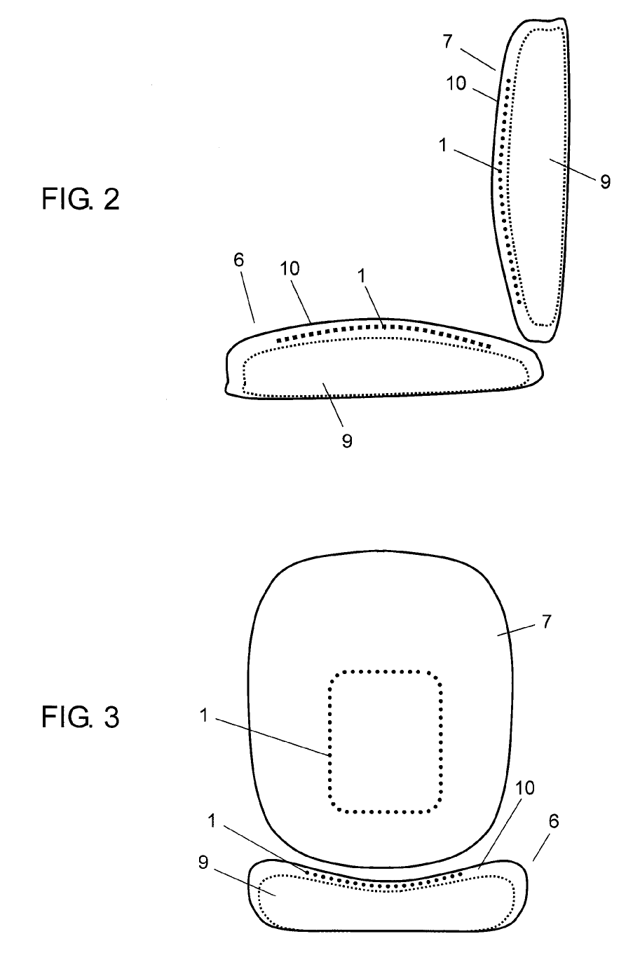

FIG. 1A and FIG. 1B are a plan view and a sectional view of a sheet heating element in accordance with a first exemplary embodiment of the present invention. FIG. 2 and FIG. 3 are a side view and a front view showing a vehicle seat mounted with the sheet heating element shown in FIG. 1A.

Sheet heating element 1 includes electrically insulative substrate 2 and first electrode (hereinafter referred as “electrode”) 3A, second electrode (hereinafter referred as “electrode”) 3B, and polymer resistor 4. Electrodes 3A, 3B are often described as electrodes 3 in the following. Electrodes 3A, 3B are disposed on substrate 2 in a bilaterally-symmetric fashion to each other and partially sewed on substrate 2 by thread 3C. Polymer resistors 4 are formed on substrate 2 with electrodes 3 disposed thereon, which are extruded in the form of film by a T-die extruding method. As a result, polymer resistor 4 is fusion-bonded on electrodes 3 and substrate 2.

The central portion of sheet heating element 1 is punched after fusion-bonding polymer resistors 4 onto electrodes 3 and substrate 2. Sheet heating element 1 is configured in this way. Lead wires for supplying power from a power source to electrodes 3A, 3B are not shown. In addition, the punching portion is not limited to the central portion. It is allowable to punch other portion depending upon the material and shape of surface skin 10 of the seat. In that case, the wiring pattern of electrodes 3 may be changed.

In this configuration, unlike the conventional sheet heating element configured in five layers with a substrate, polymer resistor, fusion-bonding resin, and coating material, sheet heating element 1 is configured in three layers with substrate 2, a pair of electrodes 3, and polymer resistors 4. Accordingly, it is easier to display flexibility and to assure lower cost.

Also, electrodes 3 are sewed on substrate 2. In this configuration, the material cost can be reduced, but greater man-hour is required for processing. However, the processing cost can also be reduced when manufactured in a district where the processing rate is lower.

Polymer resistor 4 is electrically connected to electrodes 3 by a fusion-bonding method. In this way, electrodes 3 and polymer resistors 4, and substrate 2 and polymer resistors 4 are respectively connected to each other by a fusion-bonding method. As a result, electrodes 3 are disposed between substrate 2 and polymer resistor 4 in a state of being electrically connected with electrodes 3.

Substrate 2 is, for example, needle punch type non-woven fabric made of polyester fiber. It is preferable to use woven fabric other than this. It is preferable that substrate 2 is impregnated with flame retardant and given incombustibility.

Electrodes 3 are formed of tin-plated twisted copper wires having a resistance value of 0.03 ohm/cm or less, for example. Other than this, it is also preferable to use braided copper wires after plated. In this way, using the plated and twisted copper wires or the plated and braided copper wires to form electrodes 3, it is possible to make electrodes 3 inexpensive and excellent in flexibility.

Also, electrodes 3 are preferable to be disposed in a wave-form fashion as shown in FIG. 1A. In this configuration, electrodes 3 are excellent in flexibility because it has sufficient allowance for its length even when it is expanded or deformed, thanks to the wave-form. Further, the electric potential is equalized in a region corresponding to the wave width in polymer resistor 4, and the heat generating portion of polymer resistor 4 becomes uniform in quality.

Polymer resistor 4 is formed of a kneaded mixture of fibrous conductor and resin composition. As the fibrous conductor, it is possible to use tin plated and antimony doped titanium oxide that is fibrous conductive ceramic, for example. As the resin composition, for example, modified polyethylene having carboxyl group as specific reaction resin that generates PTC characteristic, modified polyethylene having epoxy group as reactive resin that reacts with the specific reaction resin, and ethylene vinyl alcohol copolymer as liquid-proof resin component are respectively employed to be used in the form of a mixture.

Also, it is preferable to add a flame retardant to polymer resistors 4. In this way, the combustibility of the resin composition can be reduced by the flame retardant, and as a result, it is possible to realize the incombustibility of polymer resistors 4. As a flame retardant, it is possible to use a phosphoric flame retardant such as ammonium phosphate and tricresyl phosphate, a nitric flame retardant such as melamine, guanidine and guanyl urea, or a combination of these. Also, it is possible to use an inorganic flame retardant such as magnesium hydroxide and antimony trioxide, or a halogen flame retardant of bromic or chloric type.

In the manufacture of polymer resistors 4, mixture A including the specific reaction resin that generates PTC characteristic, the liquid-proof resin, and the fibrous conductor is previously prepared, while mixture B formed of the reactive resin and the flame retardant is previously prepared. And both of them are mixed and extruded from a T-die into a film. Polymer resistors 4 are manufactured in this way. The weight ratio of the fibrous conductor, resin composition, and flame retardant is 35:5:60, for example, and the specific reaction resin, the reactive resin, and the liquid-proof resin are used in equal quantity.

Sheet heating element 1 as a heater is mounted in seat 6 that is a seat of a vehicle or in back rest 7 disposed so as to rise from seat 6, so as to dispose substrate 2 on the surface side thereof. Seat substrate 9 and surface skin 10 are used for seat 6 and back rest 7. Seat substrate 9 such as urethane pad changes in shape when a load is applied by the person taking the seat, and restores its original shape when the load is released. Seat substrate 9 is covered with surface skin 10. That is, sheet heating element 1 is mounted with polymer resistors 4 disposed on the seat substrate 9 side, and substrate 2 on the surface skin 10 side. In order to correspond to a hanging portion (not shown) of seat 6 or back rest 7, there is sometimes provided an extension (not shown) of substrate 2 for the hanging purpose at the central portion or peripheral portion.

In this way, thin sheet heating element 1 is disposed along seat substrate 9 and surface skin 10 which may change in shape. Accordingly, sheet heating element 1 similarly has to change in shape in accordance with the deformation of seat 6 and back rest 7. Therefore, it is necessary to design various heating patterns and to change the position of electrodes 3 to achieve the purpose. Here, the detailed description is omitted.

A pair of wide electrodes 3A, 3B disposed so as to be opposed to each other are disposed along the outer portion in the lengthwise direction of sheet heating element 1. Power is supplied from electrodes 3A, 3B to polymer resistors 4 disposed so as to be placed on electrode 3A, 3B, and thereby, the current flows in polymer resistors 4, and then polymer resistors 4 generate heat.

Polymer resistor 4 has PTC characteristic, thus it displays a self-temperature controlling function to adjust the temperature to a specific level when the temperature rises causing the resistance value to increase. That is, polymer resistors 4 provide sheet heating element 1 with excellent safety and a function of making temperature control unnecessary. Also, as a vehicle seat heater mounted in a vehicle seat, sheet heating element 1 is able to satisfy the requirements for the feel of the seat, incombustibility, and liquid-proof property. The requirement for the feel of the seat can be satisfied when the element is free from causing paper wrinkling noise, and equivalent in elongation characteristic to the seat skin material, that is, the load is less than 7 kgf as against 5% elongation.

Also, as compared with a conventional tubing heater, sheet heating element 1 having PTC characteristic is able to display quick heating and energy saving abilities. A tubing heater required a temperature controller. Such a temperature controller serves to turn the power ON/OFF to control the heating temperature of the tubing heater. Since the heater temperature with power turned ON increases to about 80° C., it is necessary to dispose the heater a certain distance apart from surface skin 10. In the case of sheet heating element 1, on the other hand, the heating temperature is self-controlled within a range of 40° C. to 45° C. Accordingly, it is possible to dispose sheet heating element 1 in a position close to surface skin 10. Since sheet heating element 1 is low in heating temperature and can be disposed in the vicinity of surface skin 10, it is possible to ensure quick heating and to reduce externally discharging losses of heat. Accordingly, it is possible to meet the requirement for energy saving.

Further, sheet heating element 1 can be provided with incombustibility by using incombustible non-woven fabric for substrate 2, and also, by using an incombustible fibrous conductor for polymer resistor 4 and mixing a flame retardant therein as needed. Sheet heating element 1 itself is required to satisfy the incombustibility specified in U.S. Standards for Incombustibility of Motorcar Interior FMVSS302, and it is possible to satisfy the requirement by disposing substrate 2 made of incombustible non-woven fabric on the upper side of the seat. In FMVSS302 standards, the outline of incombustibility is defined as follows. That is, the specimen does not catch fire even when a gas burner is applied to the surface thereof in a box-like testing device, or within the range of a half inch in thickness from the surface, the flame does not spread at a speed of over 4 inches per minute. Also, in the case of extinction within 60 seconds, it does not extend more than 2 inches from the firing point.

Accordingly, those that are self-extinction type as well as being incombustible or less than 80 mm/minute in burning speed under the condition of horizontal firing conform to the standards. That is, incombustibility means that when a gas flame is applied to an end of the specimen, and the gas flame, the firing source, is extinguished 60 seconds later, the fired portion of the specimen is charred but free from burning. Also, self-extinction means that even when the specimen is fired, it goes out within 60 seconds and within 2 inches.

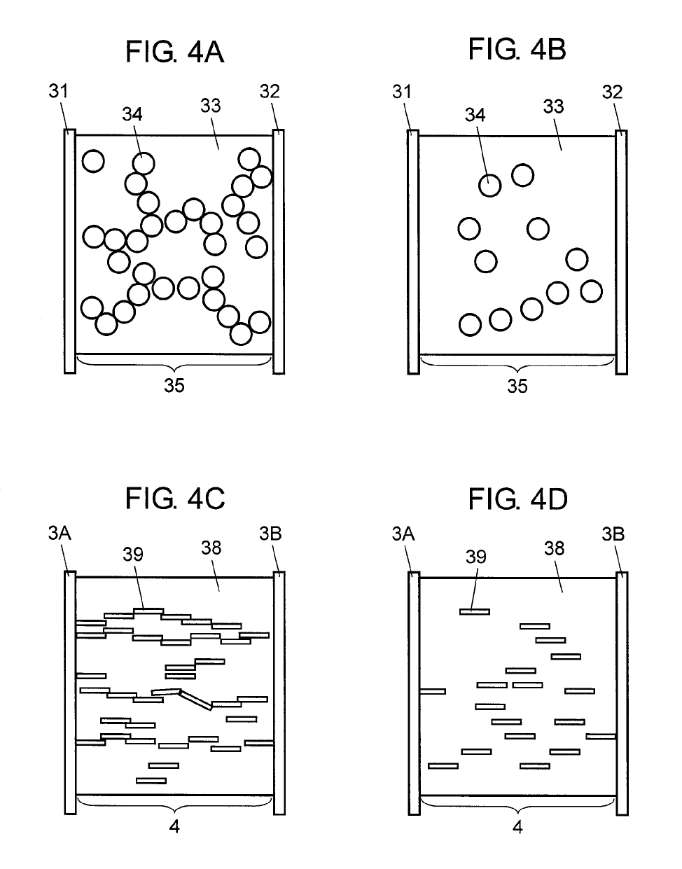

Further, it is preferable to use a fibrous or flake-like conductor for polymer resistors 4. In this way, the resistance value stability will be enhanced. The PTC generating mechanism of polymer resistor 4 is supposed to be as follows. FIG. 4A to FIG. 4D are conceptual diagrams for describing the PTC generating mechanism. In FIG. 4A and FIG. 4B, granular conductor 34 such as carbon black is used, and in FIG. 4C and FIG. 4D, fibrous conductor 39 is used.

In the case of polymer resistor 35 using granular conductor 34 such as carbon black as conductor, as shown in FIG. 4A, granular conductor 34 has a structure but its conduction path is in a state of so-called grain-to-grain point contact. Therefore, when a current is applied between electrodes 31, 32, resin composition 33 generates heat as shown in FIG. 4B, and the heat causes the conduction path to sensitively break due to the change in specific volume. Thus, resistance temperature characteristics including rapid increase in resistance value are generated.

On the other hand, fibrous conductor 39 is used for polymer resistors 4. Consequently, as shown in FIG. 4C, the contact points of the conduction path formed are increased. Therefore, the conduction path is maintained as the change in specific volume is very slight. However, in the case of great change in specific volume at the melting point, for example, resistance temperature characteristics of generating great change in resistance value are generated the same as for carbon black. Thus, in the case of polymer resistor 4, the stability of resistance value is enhanced because of the increase of contact points due to overlap of fibrous conductors 39 as against the hysteresis of specific volume in accordance with crystallization of resin composition 38 that generates PTC characteristic.

Further, it is preferable to mix the liquid-proof resin in resin composition 38 of polymer resistors 4. In this way, it is possible to provide polymer resistors 4 with liquid-proof property. Liquid-proof property stands for resistance stability when various kinds of liquids such as engine oil being non-polar oil, brake oil being polar oil, and organic solvents such as thinner having low molecule come into contact with polymer resistors 4. Other than ethylene vinyl alcohol copolymer, it is possible to use thermoplastic polyester resin, polyamide resin, and polypropylene resin, individually or in combination as the liquid-proof resin.

In order to satisfy the elongation characteristic required for sheet heating element 1 built into a seat, it is necessary to include flexible polymer resistors 4 and flexible resin composition 38 thereof. To have flexibility means that flexible resin composition 38 is non-crystalline. Generally, non-crystalline resin is easily swelled when it comes into contact with liquids of various kinds and changes in specific volume. This causes the resistance value to increase just like as for the change in specific volume due to heat. When resin composition having no liquid-proof property is used for the polymer resistor, and the resin composition is swelled, the polymer resistor will not easily restore its resistance value, thus generates no heat. Accordingly, it is preferable to add highly crystalline liquid-proof resin to resin composition 38. Thus, due to the reactive resin having flexibility, the specific reaction resin that generate PTC characteristic, the fibrous conductor, and the liquid-proof resin are partially chemically bonded to each other. As a result, the liquid-proof property of polymer resistor 4 can be greatly improved. In the case of polymer resistors 4 configured in the above-mentioned mixing ratio, it is possible to sufficiently satisfy the liquid-proof property standard. More specifically, the change in resistance value before and after a test is +50% or less when power is supplied for 24 hours after the lapse of 24 hours after dropping liquids of various kinds, which is thereafter left at the room temperature for 24 hours.

As a combination of the functional group of reactive resin and specific reaction resin of resin composition 38, the following combination is possible other than the epoxy group and carboxylic acid group.

Epoxy group reacts with carbonyl group such as maleic anhydride group, ester group, hydroxyl group, amino group, etc. other than the carboxylic acid group for addition polymerization. It is preferable to use specific reaction resin having one of such functional groups. Also, it is possible to use oxazolic group or maleic anhydride group as reactive functional group. Thus, resin composition 38 has a structure cross-linked via at least one of oxygen atom and nitrogen atom. The reactive functional group of the reactive resin reacts with the functional group of specific reaction resin that is a polar group for providing chemical-bonding. Accordingly, it is possible to enhance the thermal stability as compared with the case of using only specific reaction resin.

In this way, since resin composition 38 includes the reactive resin and the specific reaction resin that generates PTC characteristic, fibrous conductor 39 can be caught by the adhering and bonding force of the reactive resin. Further, the conduction path of fibrous conductor 39 becomes stabilized by the bonding force between the reactive resin and the specific reaction resin.

When the heating temperature is as relatively low as 40 to 50° C. as in a vehicle seat heater, it is preferable to use ester ethylene copolymer such as ethylene vinylacetate copolymer, ethylene acrylethyl copolymer, or ethylene methyl metacrylate copolymer, which is low melting-point resin, as specific reaction resin that generates PTC characteristic. Other than those, it is also possible to use reactive resin as the specific reaction resin when the heat generating temperature is appropriate.

As fibrous conductor 39, other than titanium oxide type conductive ceramic fiber, it is preferable to use potassium titanate type conductive ceramic whisker or conductive ceramic fiber, metallic fiber such as copper and aluminum, insulative ceramic fiber formed with conductive layer on the surface such as metal-plated glass fiber, carbon fiber such as PAN type carbon fiber, carbon nano-tube, or fibrous conductive polymer formed of polyaniline. Also, it is preferable to use flake-like conductor in place of fibrous conductor 39. As the flake-like conductor, it is possible to use conductive ceramic whisker or metal flake, insulative ceramic flake or whisker formed with conductive layer on the surface such as metal-plated mica flake, or flaky graphite. Also, from the view point of realizing the incombustibility of polymer resistors 4, it is preferable to use incombustible material such as metal and ceramic.

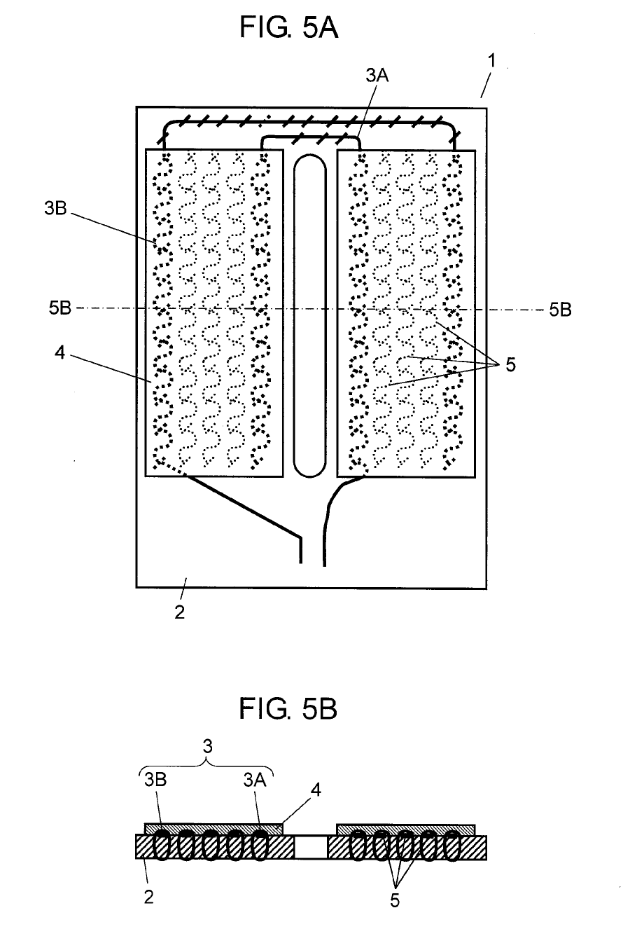

Next, a preferable structure for equalizing the potential distribution in polymer resistors 4 is described in the following. FIG. 5A is a plan view of another sheet heating element in the present exemplary embodiment. FIG. 5B is a sectional view along the line 5B-5B in FIG. 5A. In this configuration, there are provided a plurality of auxiliary electrodes 5 between electrodes 3A, 3B. The configuration other than this is same as in FIG. 1A and FIG. 1B.

In the configuration of FIG. 1A, a portion between electrodes 3A and 3B may be partially thermally insulated, thus the resistance value thereof may be increased, resulting in concentration of the potential depending upon the condition. If the condition goes on, the temperature of the part of polymer resistors 4 will become higher than that of other portions, that is, there arises a so-called hot line phenomenon. As in FIG. 5A, the generation of hot line can be avoided with the potential equalized by disposing auxiliary electrode 5. As a result, the safety of sheet heating element 1 is enhanced.

For auxiliary electrode 5, it is preferable to use tin-plated twisted copper wire or tin-plated braided copper wire which is the same as for electrode 3, and it is preferable to adopt a wave-form configuration. The number of auxiliary electrodes 5 is not limited. It is allowable to decide the number of auxiliary electrodes 5 according to the size of polymer resistor 4, using more than one. That is, at least a pair of auxiliary electrodes 5 are disposed parallel with electrodes 3, and are electrically connected to polymer resistors 4.

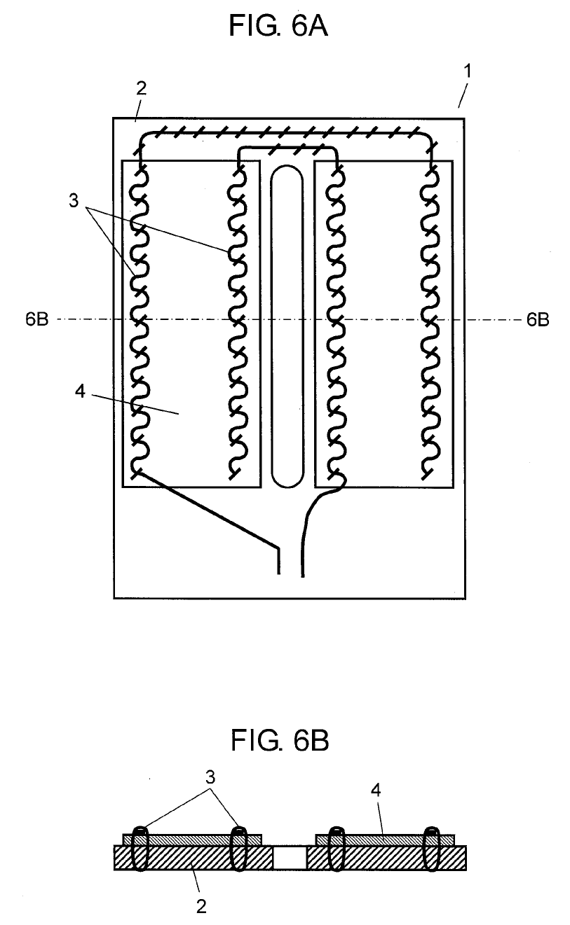

A different arrangement and structure of polymer resistors 4, electrodes 3, and substrate 2 will be described in the following. FIG. 6A is a plan view of further another sheet heating element in the present exemplary embodiment. FIG. 6B is a sectional view along the line 6B-6B in FIG. 6A. In this configuration, polymer resistors 4 are thermally laminated on substrate 2 in the form of film, and thereafter, electrodes 3 are sewed thereon. And they are heated under pressure in order to ensure the electrical connection between electrodes 3 and polymer resistor 4. That is, electrodes 3 are exposed from polymer resistor 4. The materials for the component elements are same as in the configuration of FIG. 1A.

Also in this configuration, the same as in the configuration of FIG. 1A, sheet heating element 1 can be obtained as a vehicle seat heater. Also, in the configuration of FIG. 1A, electrodes 3 are located between substrate 2 and polymer resistors 4, while in the configuration of FIG. 6A, electrodes 3 are located on polymer resistor 4. Therefore, it is easy to confirm the position of electrodes 3, and the central portion of substrate 2 can be reliably punched for the purpose of increasing the flexibility. Also, because of freedom for the arrangement of electrodes 3, the process of affixing polymer resistors 4 to substrate 2 can be performed in common when manufacturing sheet heating elements of various heating patterns. It is also preferable to provide this configuration with auxiliary electrodes 5 shown in FIG. 5A.

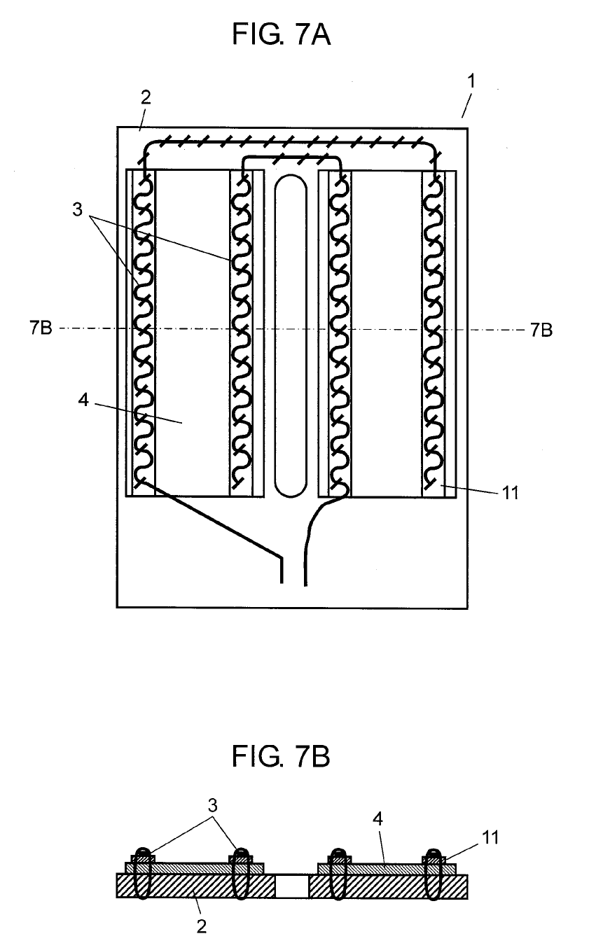

A preferable structure for enhancing the flexibility of sheet heating element 1 will be described in the following. FIG. 7A is a plan view of another sheet heating element in the present exemplary embodiment. FIG. 7B is a sectional view along the line 7B-7B in FIG. 7A. In this configuration, slidable conductors 11 are previously disposed on polymer resistors 4, and thereafter, electrodes 3 are disposed on slidable conductors 11. The other configurations are same as in FIG. 6A. Slidable conductor 11 is, for example, a film prepared by drying a paste using graphite or a film of resin compound prepared by kneading graphite.

In this configuration, since electrode 3 slides on slidable conductor 11, the flexibility of sheet heating element 1 is enhanced, also the electrical connection between electrodes 3 and polymer resistor 4 becomes more reliable. It is preferable to provide this configuration with auxiliary electrodes 5 shown in FIG. 5A. Also, it is preferable to dispose slidable conductors 11 in the positions where auxiliary electrodes 5 are disposed.

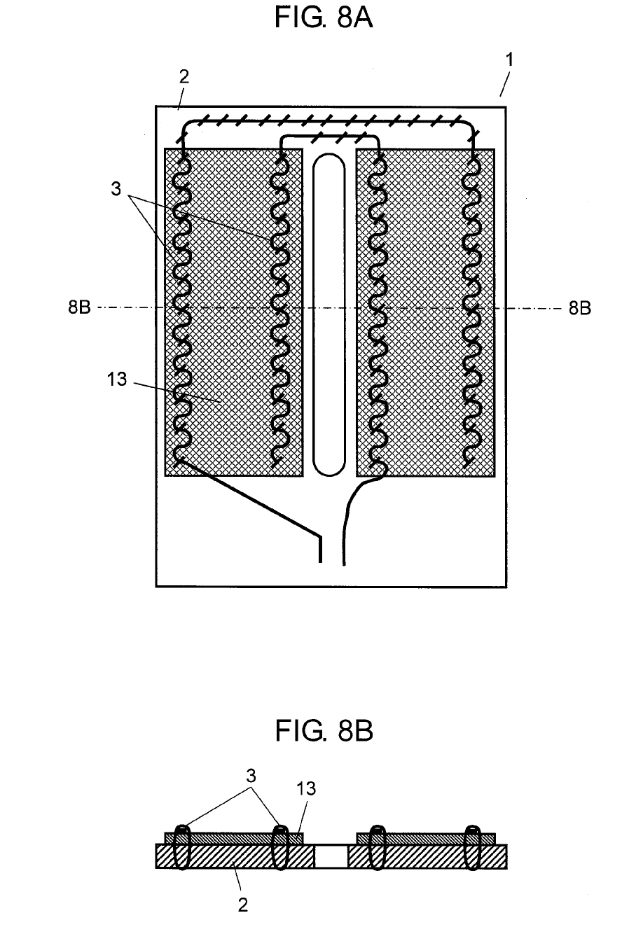

Another preferable structure for enhancing the flexibility of sheet heating element 1 will be described in the following. FIG. 8A is a plan view of another sheet heating element in the present exemplary embodiment. FIG. 8B is a sectional view along the line 8B-8B in FIG. 8A. In this configuration, polymer resistors 13 are used in place of polymer resistors 4. Polymer resistors 13 are manufactured by impregnating mesh-like non-woven fabric or woven fabric having openings with ink formed from the same material for polymer resistor 4, followed by drying. The configurations other than this are same as in FIG. 6A.

In this configuration, polymer resistor 13 has the openings and is changeable in shape. Accordingly, sheet heating element 1 using polymer resistor 13 becomes more flexible.

In the above embodiment, electrodes 3 and polymer resistor 4, 13 are thermally bonded to each other, but the present invention is not limited to this. Electrodes 3 and polymer resistor 4, 13 can be electrically connected to each other by bonding via conductive adhesive or just by pressing them against each other to make mechanical contact. Further, it is preferable to dispose a coating layer on polymer resistors 4, 13, electrodes 3 or auxiliary electrodes 5 on the opposite side of substrate 2 for the purpose of enhancing the wear resistance. The coating layer is preferable to cover at least polymer resistors 4 that is lower in strength. Considering flexibility, it is preferable to use a thin coating layer. Also, a thinner coating layer can be used as compared with the conventional one because the electrodes have excellent weather resistance.

It is preferable to dispose sheet heating element 1 thus configured on seat 6 or back rest 7 so that substrate 2 is on the surface side. That is, substrate 2 serves as a cushion, and therefore, the feel of the seat is not affected because the thickness and hardness of electrodes 3 or auxiliary electrodes 5 are felt on the seat surface. Also, using incombustible non-woven fabric as substrate 2 and disposing it on the surface side, spreading of fire in the combustion test can be prevented, and it is possible to obtain a practical seat.

### Second Exemplary Embodiment

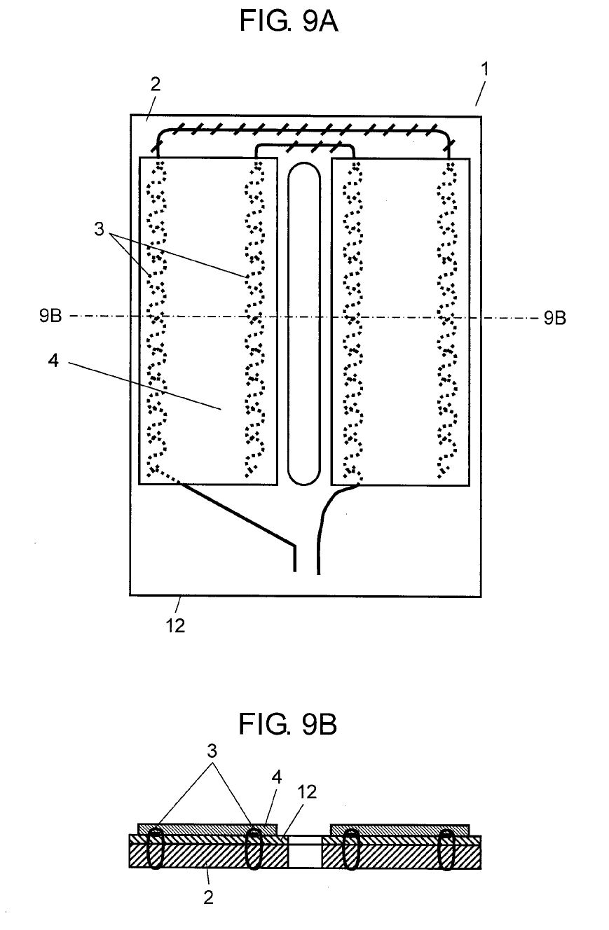

FIG. 9A and FIG. 9B are respectively a plan view and a sectional view of a sheet heating element in accordance with a second exemplary embodiment of the present invention. The difference from the configuration of FIG. 1A and FIG. 1B in the first exemplary embodiment is such a point that liquid-proof film 12 is affixed on substrate 2, and electrodes 3 are sewed on liquid-proof film 12. Also, the resin composition of polymer resistor 4 is a combination of the specific reaction resin that generates PTC characteristic and the reactive resin. The configurations other than those are same as in FIG. 1A and FIG. 1B in the first exemplary embodiment.

In the present exemplary embodiment, liquid-proof film 12 is disposed in the direction of penetration of the liquid, that is, on the substrate 2 side. Accordingly, polymer resistors 4 are suppressed from coming in contact with the liquid, and consequently, the liquid-proof property of sheet heating element 1 is enhanced. In this configuration as well, the standard for liquid-proof property can be satisfied the same as in the first exemplary embodiment.

Due to this configuration, unlike the conventional sheet heating element formed of five layers of a substrate, electrodes, a polymer resistor, a fusion-bonding resin, and a coating material, sheet heating element 1 is formed of four layers of substrate 2, liquid-proof film 12, a pair of electrodes 3, and polymer resistors 4. Accordingly, it is easier to display flexibility, and lower in cost.

Liquid-proof film 12 is preferable to be formed from incombustible material having incombustibility at least defined in the FMVSS302 standards. Thus, the incombustibility of sheet heating element 1 is enhanced. As such an incombustible material, ethylene vinyl alcohol copolymer, plastic polyester resin, polyamide resin, and polypropylene resin can be used individually or in combination.

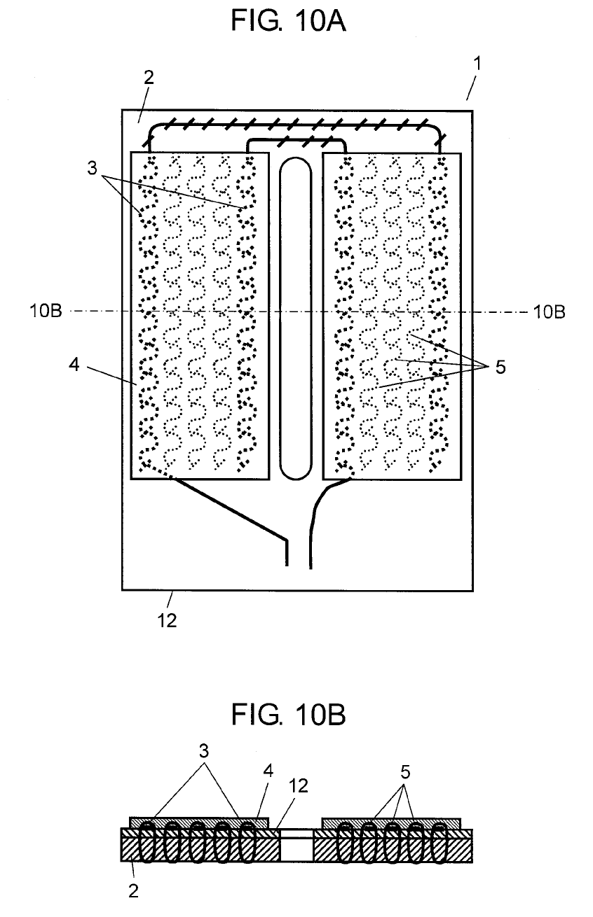

As same as in FIG. 5A and FIG. 5B of the first exemplary embodiment, the case of providing the configuration of FIG. 9A and FIG. 9B with auxiliary electrodes 5 will be briefly described in the following. FIG. 10A is a plan view of another sheet heating element in the present exemplary embodiment, and FIG. 10B is a sectional view along the line 10B-10B.

Thus, providing the configuration of FIG. 9A with auxiliary electrode 5 between electrodes 3 as same as in FIG. 5A of the first exemplary embodiment, it is possible to avoid the generation of hot line. As a result, the safety of sheet heating element 1 can be further enhanced.

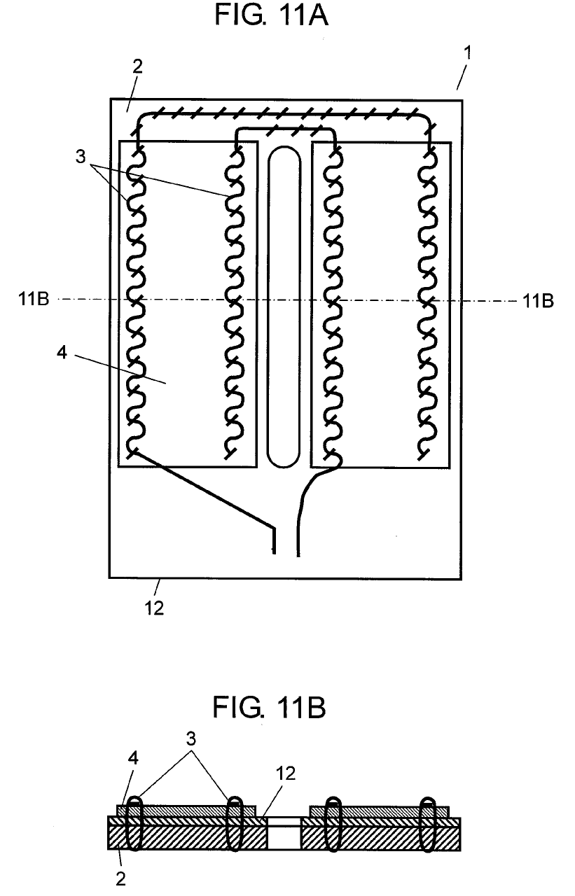

Next, the case of disposing electrodes 3 on polymer resistor 4 as same as in FIG. 6A and FIG. 6B of the first exemplary embodiment will be briefly described. FIG. 11A is a plan view of further another sheet heating element in the present exemplary embodiment, and FIG. 11B is a sectional view along the line 11B-11B.

Polymer resistors 4 are laminated in the form of film on liquid-proof film 12, followed by sewing electrodes 3 thereon. And they are heated under pressure in order to make the electrical connection between electrodes 3 and polymer resistor 4 more reliable. In this way, the same as in the configuration shown in FIG. 6A and FIG. 6B of the first exemplary embodiment, sheet heating element 1 as a vehicle seat heater can be obtained as well. And, the same effects as in FIG. 6A and FIG. 6B of the first exemplary embodiment can be obtained. It is preferable to provide this configuration with auxiliary electrodes 5 shown in FIG. 10A.

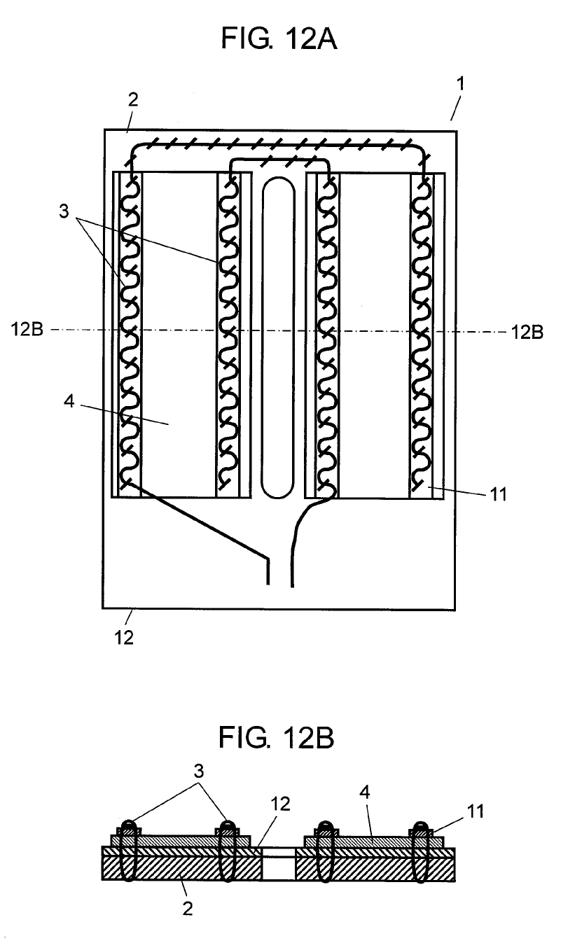

Next, the same as in FIG. 7A and FIG. 7B of the first exemplary embodiment, the case of disposing slidable conductors 11 will be briefly described. FIG. 12A is a plan view of another sheet heating element in the present exemplary embodiment, and FIG. 12B is a sectional view along the line 12B-12B.

As described above, slidable conductors 11 are previously disposed on polymer resistors 4, and electrodes 3 are disposed thereon. Accordingly, electrode 3 can slide on slidable conductor 11, further enhancing the flexibility of sheet heating element 1. Also, the electrical connection between electrodes 3 and polymer resistor 4 becomes more reliable. That is, the same effects as in FIG. 7A and FIG. 7B of the first exemplary embodiment can be obtained. It is preferable to provide this configuration with auxiliary electrodes 5 shown in FIG. 10A.

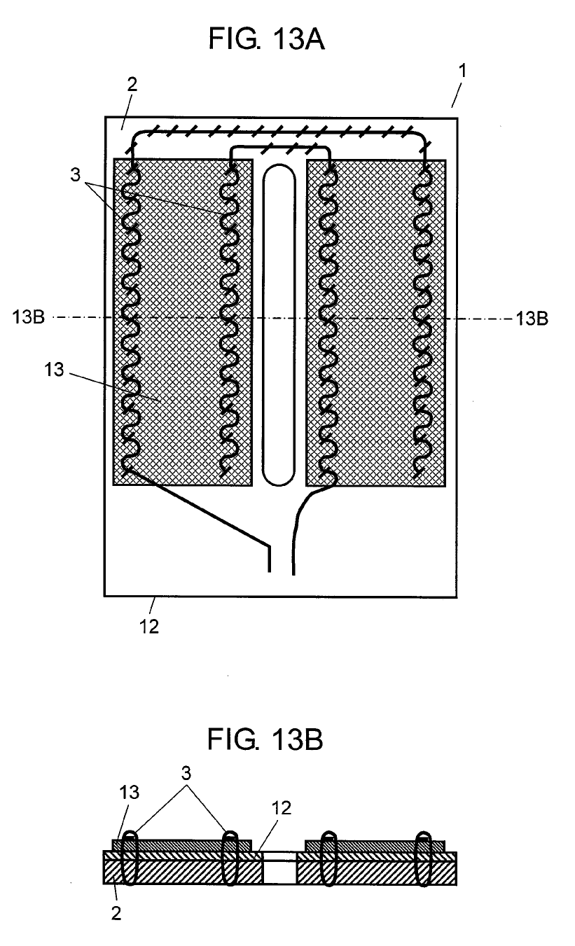

Next, the same as in FIG. 8A and FIG. 8B of the first exemplary embodiment, the case of using polymer resistors 13 in place of polymer resistors 4 will be briefly described. FIG. 13A is a plan view of further another sheet heating element in the present exemplary embodiment, and FIG. 13B is sectional view along the line 13B-13B.

Polymer resistor 13 is manufactured by impregnating mesh-like non-woven fabric or woven fabric having openings with ink formed from the same material for polymer resistor 4, followed by drying. In this configuration, polymer resistor 13 has openings and is changeable in shape. Accordingly, sheet heating element 1 using polymer resistor 13 becomes more flexible. That is, the same effects as in FIG. 8A and FIG. 8B of the first exemplary embodiment can be obtained.

It is preferable to dispose sheet heating element 1 thus configured on seat 6 or back rest 7 shown in FIG. 2 and FIG. 3 so that substrate 2 is on the surface side. That is, substrate 2 serves as a cushion, and therefore, the feel of the seat is not affected because the thickness and hardness of electrodes 3 or auxiliary electrodes 5 are felt on the seat surface. Also, using incombustible non-woven fabric as substrate 2 and disposing it on the surface side, spreading of fire in the combustion test can be prevented, and it is possible to obtain a practical seat. That is, it is preferable to dispose sheet heating element 1 in the present exemplary embodiment on seat 6 or back rest 7 as well as in the first exemplary embodiment.

### Third Exemplary Embodiment

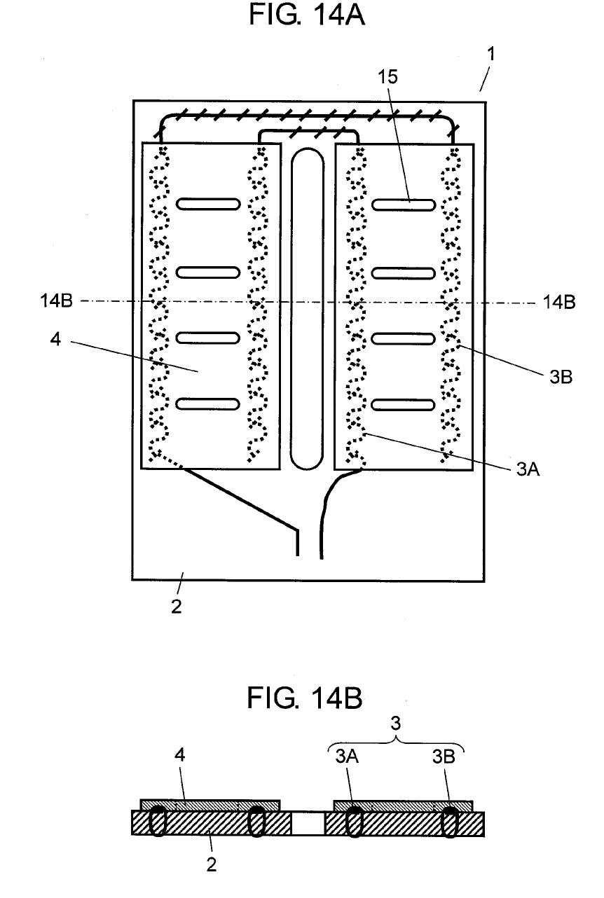

FIG. 14A and FIG. 14B are respectively a plan view and a sectional view of a sheet heating element in the exemplary embodiment of the present invention. The difference from the configuration of FIG. 1A and FIG. 1B in the first exemplary embodiment is such a point that at least one of substrate 2 and polymer resistor 4 is provided with slits 15. Slit 15 serves as a deformation absorbing portion that absorbs deformation generated by external forces. The configurations other than this are same as in FIG. 1A and FIG. 1B of the first exemplary embodiment.

In the present exemplary embodiment, the same as in the first exemplary embodiment, electrodes 3A, 3B are sewed on substrate 2, and polymer resistors 4 are extruded in the form of film by means of T-die extrusion method, then polymer resistors 4 are thermally fusion-bonded onto electrodes 3 and substrate 2. And after the central portion of substrate 2 is punched, polymer resistors 4 are punched by Thomson punch in the positions between electrodes 3A and 3B, and thereby, there are provided slits 15 that penetrate from polymer resistor 4 to substrate 2.

The portions to be punched by Thomson punch are not limited to those positions. It is allowable to punch other portions in accordance with the surface skin condition of the seat. In that case, it is necessary to change the wiring patterns of electrodes 3, but there is no problem with this. The punched portion at the center can also be considered as a deformation absorbing portion, but the central portion is often punched because of the surface skin shape of the seat and it is discriminated as a deformation absorbing portion.

It is also allowable to extrude polymer resistors 4 in the form of film by means of T-die extrusion method onto substrate 2 provided with slits 15 previously formed by punching by Thomson, followed by fusion-bonding of polymer resistors 4 onto electrodes 3 and substrate 2. Or, it is allowable to extrude polymer resistors 4 as films by means of T-die extrusion method on a separator (not shown) made of polypropylene, release paper or the like, and to make slits 15 in polymer resistors 4 by punching. Slits 15 are formed only in substrate 2 in the former case, and only in polymer resistors 4 in the latter case.

As described above, sheet heating element 1 in the present exemplary embodiment is provided with slits 15 that are the deformation absorbing portions for absorbing deformation generated by external forces. Accordingly, sheet heating element 1 is easy to change its shape against external forces and may provide a satisfactory feel of the seat.

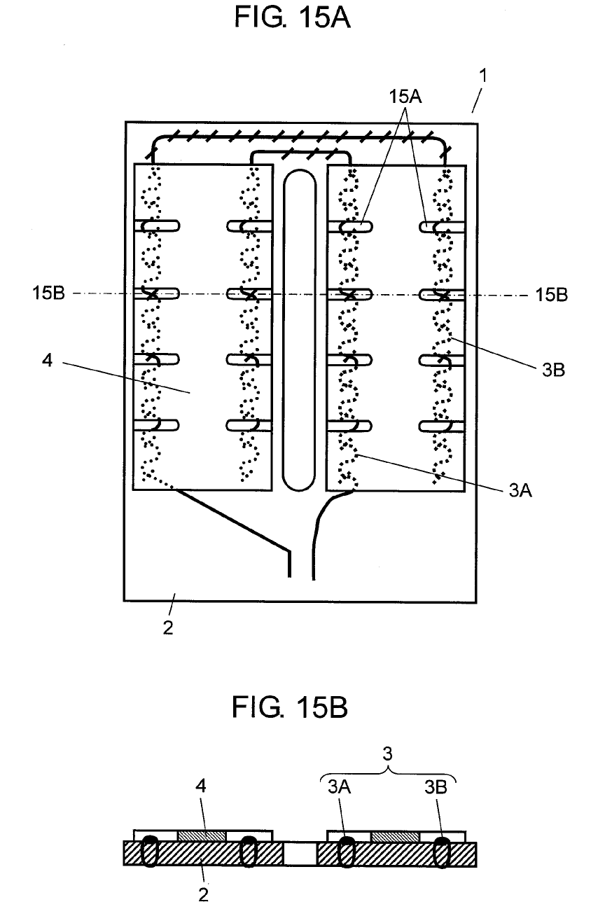

A deformation absorbing portion that is different from slit 15 will be described in the following. FIG. 15A is a plan view of another sheet heating element in the present exemplary embodiment. FIG. 15B is a sectional view along the line 15B-15B. The difference of the configuration in FIG. 15A and FIG. 15B from the configuration in FIG. 14A and FIG. 14B is such a point that there are provided notches 15A as deformation absorbing portions.

In this case, polymer resistors 4 are formed as films by means of T-die extrusion method on a separator (not shown) such as polypropylene and release paper, and at this stage, notches 15A are formed in polymer resistors 4 by punching. Subsequently, by using a heat laminator, polymer resistors 4 are affixed on substrate 2 provided with electrodes 3, followed by removing the separator to make sheet heating element 1.

In this configuration as well, electrodes 3 and polymer resistor 4 are fusion-bonded to each other, and thereby, it is possible to establish electrical connection and also to provide a satisfactory feel of the seat due to notches 15A that are the deformation absorbing portions.

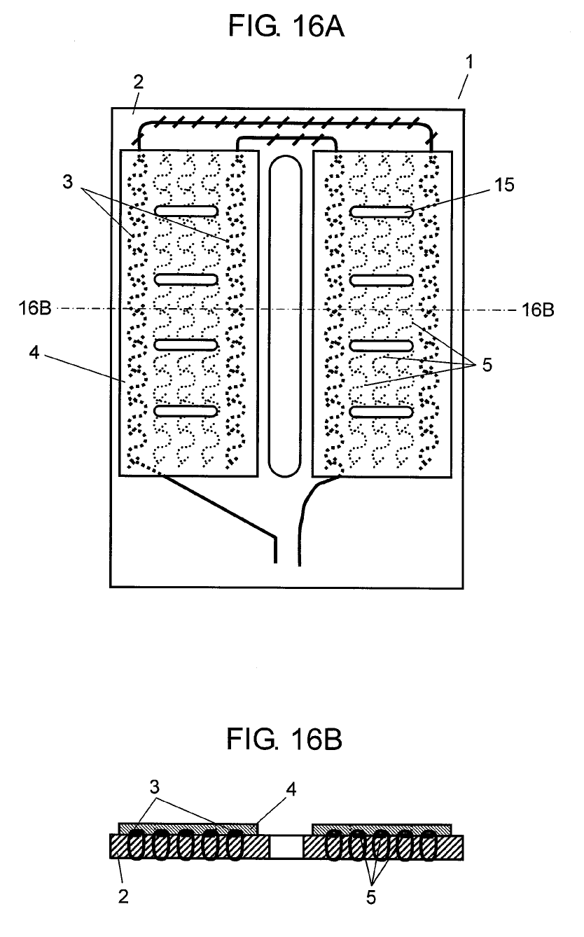

Next, the same as for FIG. 5A and FIG. 5B in the first exemplary embodiment, the case of the configuration with auxiliary electrodes 5 will be briefly described. FIG. 16A is a plan view of another sheet heating element in the present exemplary embodiment, and FIG. 16B is a sectional view along the line 16B-16B. In this case, when slits 15 are formed by punching polymer resistors 4 and substrate 2, a part of each auxiliary electrode 5 is also punched.

Thus, providing the configuration of FIG. 14A with auxiliary electrodes 5 between electrodes 3 the same as in FIG. 5A and FIG. 5B of the first exemplary embodiment, it is possible to avoid the generation of hot line. As a result, the safety of sheet heating element 1 can be further enhanced.

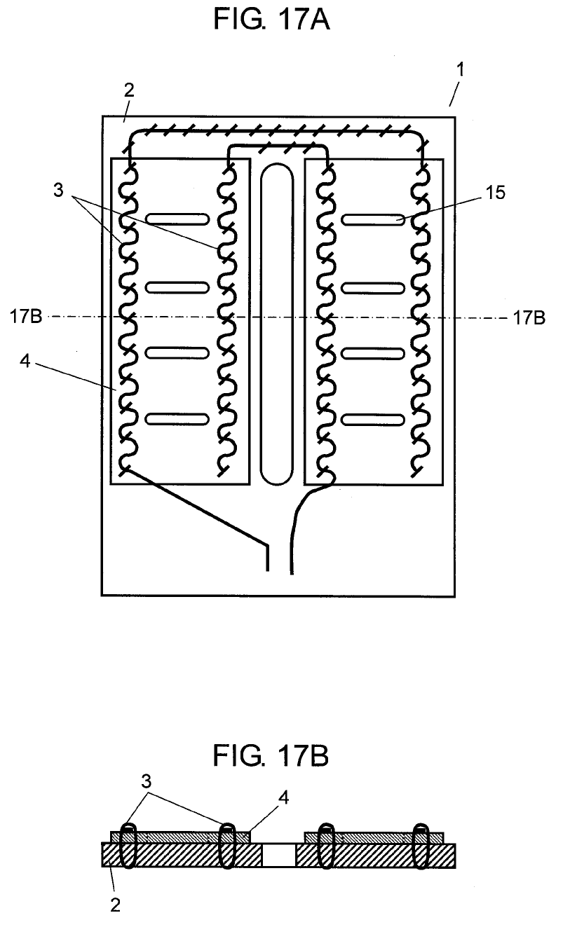

Next, the case of disposing electrodes 3 on polymer resistor 4 as same as in FIG. 6A and FIG. 6B of the first exemplary embodiment will be briefly described. FIG. 17A is a plan view of further another sheet heating element in the present exemplary embodiment, and FIG. 17B is a sectional view along the line 17B-17B.

As shown, polymer resistors 4 are laminated in the form of films on substrate 2, electrodes 3 are sewed thereon, and they are heated under pressure in order to make the electrical connection between electrodes 3 and polymer resistor 4 more reliable. After that, polymer resistors 4 and substrate 2 are punched to form slits 15. In this configuration, the same effect as in FIG. 6A and FIG. 6B of the first exemplary embodiment can be further obtained. It is preferable to provide this configuration with auxiliary electrodes 5 shown in FIG. 16A.

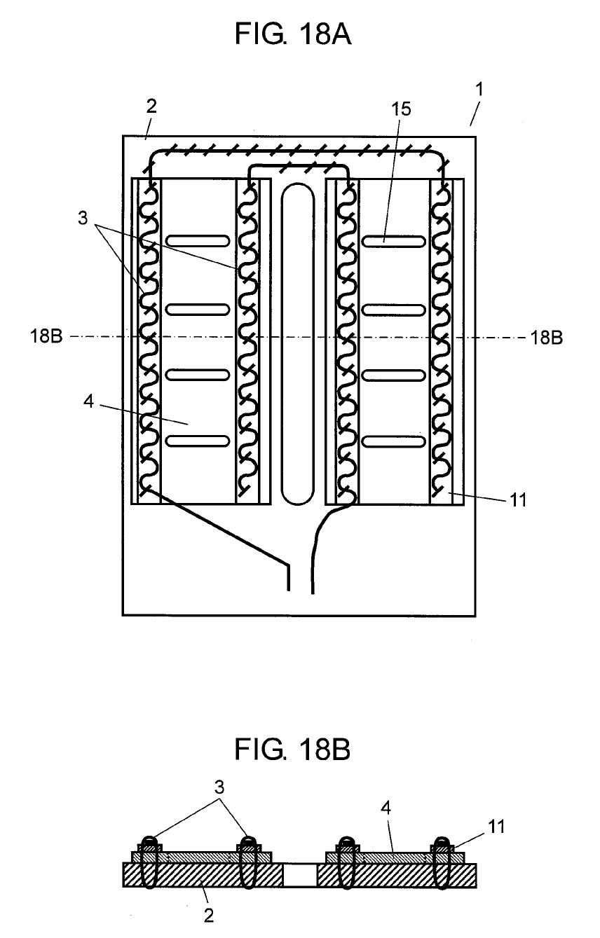

Next, the same as in FIG. 7A and FIG. 7B of the first exemplary embodiment, the case of disposing slidable conductors 11 will be briefly described. FIG. 18A is a plan view of another sheet heating element in the present exemplary embodiment, and FIG. 18B is a sectional view along the line 18B-18B.

As described above, slidable conductors 11 are previously disposed on polymer resistor 4, and electrodes 3 are disposed thereon. Accordingly, electrode 3 can slide on slidable conductor 11, further enhancing the flexibility of sheet heating element 1. Also, the electrical connection between electrodes 3 and polymer resistor 4 becomes more reliable. That is, the same effects as in FIG. 7A and FIG. 7B of the first exemplary embodiment can be further obtained. It is preferable to provide this configuration with auxiliary electrodes 5 shown in FIG. 16A.

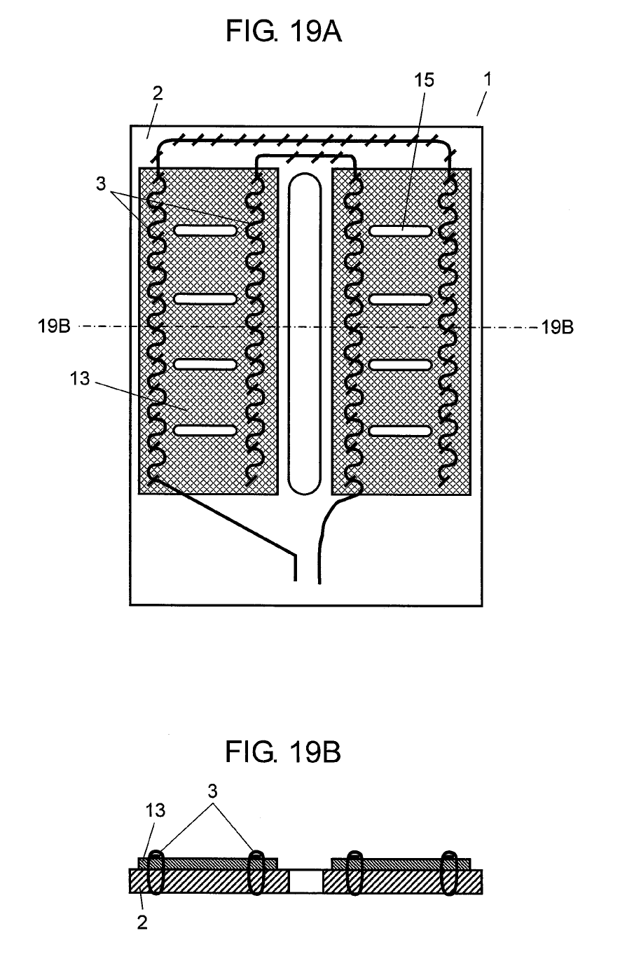

Next, the same as in FIG. 8A and FIG. 8B of the first exemplary embodiment, the case of using polymer resistors 13 in place of polymer resistors 4 will be briefly described. FIG. 19A is a plan view of further another sheet heating element in the present exemplary embodiment, and FIG. 19B is a sectional view along the line 19B-19B.

Polymer resistors 13 are manufactured by impregnating mesh-like non-woven fabric or woven fabric having openings with ink formed from the same material for polymer resistor 4, followed by drying. In this configuration, polymer resistors 13 have the openings and are changeable in shape. Accordingly, sheet heating element 1 using polymer resistors 13 becomes more flexible. That is, the same effects as in FIG. 8A and FIG. 8B of the first exemplary embodiment can be further obtained.

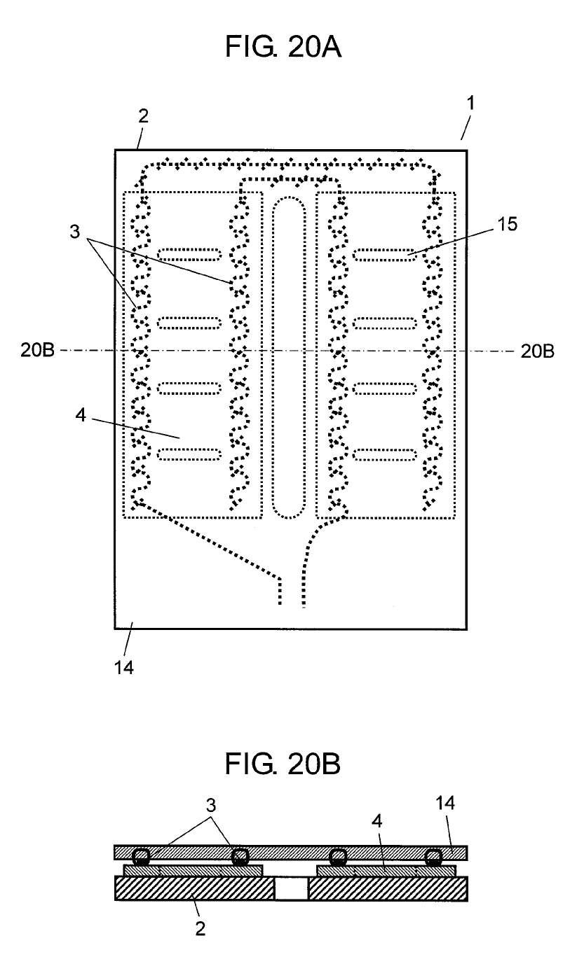

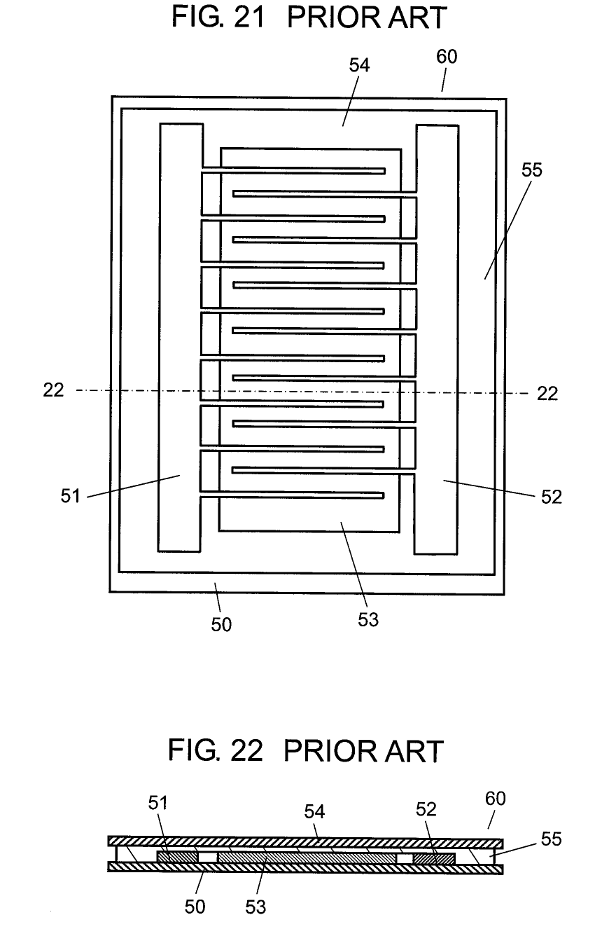

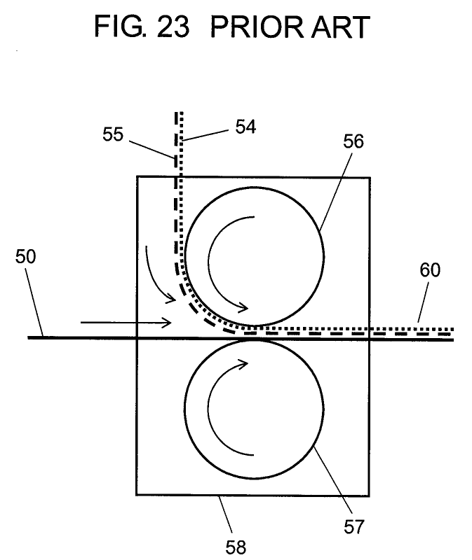

Next, a configuration with electrodes 3 disposed on another electrically insulative substrate will be described. FIG. 20A is a plan view of further another sheet heating element in the present exemplary embodiment. FIG. 20B is a sectional view along the line 20B-20B. In this configuration, insulative second substrate 14 with electrodes 3 sewed thereon and substrate 2 with polymer resistors 4 affixed thereon are thermally laminated and affixed to each other, thereby forming sheet heating element 1. Consequently, second substrate 14 is disposed opposite to the surface where substrate 2 of sheet heating element 1 is disposed. Electrodes 3 are fixed on second substrate 14.

In this configuration, polymer resistors 4 and electrodes 3 can be handled as parts separate from each other. Accordingly, it is possible to make the deformation absorbing portions, namely slits 15 or notches 15A shown in FIG. 15A in proper portions or to use them in combination. That is, in this configuration, a deformation absorbing portion can be formed in at least one of substrates 2, 14 and polymer resistors 4. In this way, it is possible to obtain sheet heating element 1 which may change its shape against external forces to provide an excellent feel of the seat.

Also, disposing second substrate 14 so as to cover at least polymer resistors 4, it serves as a coating layer described in the first exemplary embodiment.

Sheet heating element 1 in the present exemplary embodiment, having the configuration as described above, is preferable to be arranged in seat 6 or back rest 7 shown in FIG. 2, FIG. 3 so that substrate 2 is disposed on the surface side. That is, substrate 2 serves as a cushion, and therefore, the feel of the seat is not affected because the thickness and hardness of electrodes 3 or auxiliary electrodes 5 are felt on the seat surface. Also, using incombustible non-woven fabric as substrate 2 and disposing it on the surface side, spreading of fire in the combustion test can be prevented, and it is possible to obtain a practical seat. That is, sheet heating element 1 in the present exemplary embodiment is also preferable to be used in seat 6 or back rest 7 the same as for the first exemplary embodiment.

### INDUSTRIAL APPLICABILITY

The sheet heating element of the present invention has a simple structure and is flexible enough to absorb deformation generated due to external forces. The sheet heating element can be mounted on the surface of an apparatus having continuously curved surfaces or combined planes, for example. Accordingly, it can be used as a heater for a vehicle seat, steering wheel, or other apparatus necessary to be heated.

1. A sheet heating element comprising:
an electrically insulative substrate;
a pair of electrodes disposed on the substrate; and
a polymer resistor electrically connected to the pair of electrodes, including resin composition cross-linked via at least one of oxygen atom and nitrogen atom, and at least one of a fibrous conductor and a flake-like conductor which is mixed in the resin composition.

2. The sheet heating element according to claim 1,
wherein the resin composition includes a liquid-proof resin component.

3. The sheet heating element according to claim 1,
wherein the resin composition is a reaction product of specific reaction resin and reactive resin, wherein
the specific reaction resin displays PTC function and contains at least one of functional groups of carboxyl group, carbonyl group, hydroxyl group, ester group, and amino group, and
the reactive resin contains at least one of functional groups of epoxy group, oxazoline group, and anhydrous maleic acid group.

4. The sheet heating element according to claim 3,
wherein the resin composition is a reaction product of the specific reaction resin, the reactive resin, and liquid-proof resin containing at least one of ethylene vinyl alcohol copolymer, thermoplastic polyester resin, polyamide resin, and polypropylene resin.

5. The sheet heating element according to claim 1,
wherein the fibrous conductor includes at least one of conductive ceramic whisker, conductive ceramic fiber, metal fiber, insulative ceramic whisker formed with a conductive layer on a surface thereof, insulative ceramic fiber formed with a conductive layer on a surface thereof, carbon fiber, carbon nano-tube, and fibrous conductive polymer.

6. The sheet heating element according to claim 1,
wherein the flake-like conductor includes at least one of conductive ceramic whisker, metal flake, insulative ceramic whisker formed with a conductive layer on a surface thereof, insulative ceramic flake formed with a conductive layer on a surface thereof, and flaky graphite.

7. The sheet heating element according to claim 1,
wherein the polymer resistor further contains a flame retardant that provides the polymer resistor with incombustibility that satisfies at least one of the following conditions:
1) Gas flame is applied to an end of the polymer resistor, and the gas flame is put out 60 seconds later, then the polymer resistor does not burn even in case the polymer resistor is charred.
2) Gas flame is applied to an end of the polymer resistor, and even when the polymer resistor catches fire, the fire goes out in 60 seconds within 2 inches in length.
3) Gas flame is applied to an end of the polymer resistor, and even when the polymer resistor flames, flame does not spread at a speed higher than 4 inches per minute within a range of a half inch in thickness from a surface thereof.

8. The sheet heating element according to claim 1,
wherein the substrate has incombustibility that is at least equivalent to a level defined in U.S. Motorcar Safety Standards 302.

9. The sheet heating element according to claim 1,
wherein the substrate is one of woven fabric and non-woven fabric.

10. The sheet heating element according to claim 9,
wherein the electrodes are sewed on the substrate.

11. The sheet heating element according to claim 9,
wherein the electrodes are sewed on the substrate and the polymer resistor.

12. The sheet heating element according to claim 1,
wherein the electrodes are one of plated twisted copper wire and plated braided copper wire.

13. The sheet heating element according to claim 1,
wherein the polymer resistor is disposed between the substrate and the electrodes.

14. The sheet heating element according to claim 1,
wherein the polymer resistor further includes mesh-like non-woven fabric having openings, the non-woven fabric being impregnated with the resin composition and at least one of the fibrous conductor and the flake-like conductor.

15. The sheet heating element according to claim 1,
wherein the electrodes and the polymer resistor are fusion-bonded.

16. The sheet heating element according to claim 1, further comprising:
slidable conductors each disposed between one of the electrodes and the polymer resistor, electrically connecting the one of the electrodes with the polymer resistor.

17. The sheet heating element according to claim 1, further comprising:
a liquid-proof film disposed between the substrate and the polymer resistor.

18. The sheet heating element according to claim 17,
wherein the liquid-proof film is formed of an incombustible material having incombustibility that satisfies at least one of the following conditions.
1) Gas flame is applied to an end of the liquid-proof film, and the gas flame is put out 60 seconds later, then the liquid-proof film itself does not burn even in case the liquid-proof film is charred.
2) Gas flame is applied to an end of the liquid-proof film, and even when the liquid-proof film catches fire, the fire goes out in 60 seconds within 2 inches in length.
3) Gas flame is applied to an end surface of the liquid-proof film, and even when the liquid-proof film flames, flame does not spread at a speed higher than 4 inches per minute within a range of a half inch in thickness from a surface thereof.

19. The sheet heating element according to claim 18,
wherein the incombustible material contains at least one of ethylene vinyl alcohol copolymer, plastic polyester resin, polyamide resin, and polypropylene resin.

20. The sheet heating element according to claim 1, further comprising:
an electrically insulative coating layer covering at least the polymer resistor.

21. The sheet heating element according to claim 1, further comprising:
an auxiliary electrode disposed parallel with the electrodes and electrically connected to the polymer resistor.

22. The sheet heating element according to claim 1,
wherein at least one of the substrate and the polymer resistor is provided with a deformation absorbing portion capable of following deformation generated by external forces.

23. The sheet heating element according to claim 22,
wherein the deformation absorbing portion is one of a slit and a notch.

24. The sheet heating element according to claim 1,
wherein the electrodes are arranged in a wave form.

25. The sheet heating element according to claim 1, further comprising:
a second substrate with the electrodes fixed thereon, the second substrate being disposed on a surface opposite to the substrate.

26. A seat, comprising:
a seating portion, and
the sheet heating element according to claim 1 arranged so that the substrate is positioned at the surface side of the seating portion.

27. A seat, comprising:
a seating portion,
a back rest disposed so as to rise from the seating portion, and
the sheet heating element according to claim 1 arranged so that the substrate is positioned at the surface side of the back rest.
